(19) United States
(12) Patent Application Publication
(10) Pub. No.: US 2015/0139592 A1
(43) Pub. Date: May 21, 2015

(54) OPTICAL FIBER LASER AND ANTI-REFLECTION DEVICE, AND MANUFACTURING METHOD THEREOF

(71) Applicant: INDUSTRIAL TECHNOLOGY RESEARCH INSTITUTE, HSIN-CHU (TW)

(72) Inventors: HSIN-CHIA SU, Yunlin County (TW); CHIEN-MING HUANG, Taipei (TW); SHIH-TING LIN, Tainan (TW); YU-CHENG SONG, Taichung (TW); YAO-WUN JHANG, Chiayi (TW)

(73) Assignee: INDUSTRIAL TECHNOLOGY RESEARCH INSTITUTE, HSIN-CHU (TW)

(21) Appl. No.: 14/141,335

(22) Filed: Dec. 26, 2013

(30) Foreign Application Priority Data
Nov. 19, 2013 (TW) 102142102

(51) Int. Cl. G02B 6/255

(52) U.S. Cl. CPC G02B 6/2553
USPC 385/96; 156/158

(57) ABSTRACT

An anti-reflection device, comprising: a first optical fiber, having a first optical fiber core; and a second optical fiber, having a second optical fiber core which is fusion spliced to the first fiber core to form a spliced point optical fiber core. Thereby, the present disclosure provides a method for manufacturing an anti-reflection device, comprising the step of: providing a fusion splicer to perform a parameter setup process upon at least one optical fiber so as to proceed with a splice process on the at least one optical fiber based on the result of the parameter setup process, while enabling an optical fiber alignment operation, an end surface preheating operation, an optical fiber splicing operation and an optical fiber fusion stretching operation during the proceeding of the splice process.

### CROSS REFERENCE TO RELATED APPLICATION

This application also claims priority to Taiwan Patent Application No. 102142102 filed in the Taiwan Patent Office on Nov. 19, 2013, the entire content of which is incorporated herein by reference.

### TECHNICAL FIELD

The present disclosure relates to an optical fiber laser, an anti-reflection device and their manufacturing methods, and more particularly, to an anti-reflection device adapted for optical fiber lasers.

### BACKGROUND

Generally, optical fiber lasers that are available today are consisting of: a seed laser and a plurality of laser amplifiers, whereas the seed laser is coupled to the plural laser amplifier. In addition, each laser amplifier contains a physical medium that can amplify incoming light, called a gain medium, and the gain medium can be an optical fiber.

Operationally, laser beam emitted from the seed laser propagates in a zigzag manner while being fully reflected in the gain medium and thereby the power of the laser beam is amplified.

To satisfy the increasing industrial demand, high-peak-power high-energy fiber lasers are becoming more and more popular, that is, the demand for high-power fiber laser is increasing. However, there are two problems relating to the use of current high-power fiber lasers. One of which is that the machining of an object using a high-power optical fiber laser can be adversely affected by the light reflected from the object, and the other problem is that, due to the nonlinearity induced by Stimulated Brillouin Scattering (SBS) in the laser amplifiers, the stability of a high-power fiber laser system can be severely affected. A phenomenon known as stimulated Brillouin scattering (SBS) is that: for intense laser beams travelling in a medium such as an optical fiber, the variations in the electric field of the beam itself may produce acoustic vibrations in the medium via electrostriction, and the beam may undergo Brillouin scattering from these vibrations, usually in opposite direction to the incoming beam.

The aforesaid problems can induce following shortcomings. First, the output power of an optical fiber laser system is degraded; second, the laser output end can be damaged; third, the optical components in the laser amplifiers can be damaged; and fourth, the seed laser can be damaged. Therefore, it is in need of an improved fiber laser capable of overcoming the aforesaid shortcomings.

### SUMMARY

The present disclosure provides a method for manufacturing an anti-reflection device, comprising the step of: providing a fusion splicer to perform a parameter setup process upon at least one optical fiber so as to proceed with a splice process on the at least one optical fiber based on the result of the parameter setup process, while enabling an optical fiber alignment operation, an end surface preheating operation, an optical fiber splicing operation and an optical fiber fusion stretching operation during the proceeding of the splice process.

The present disclosure provide an anti-reflection device, comprising: a first optical fiber, configured with a first optical fiber core; and a second optical fiber, configured with a second fiber core; wherein, the second fiber core is spliced to the first optical fiber core to form a spliced point optical fiber core.

The present disclosure provides an optical fiber laser, comprising:
a seed laser;
a first anti-reflection device, coupled to the seed laser, further comprising:
   a first optical fiber, configured with a first optical fiber core; and
   a second optical fiber, configured with a second optical fiber core in a manner that the second optical d fiber core is spliced to the first optical fiber core to form a spliced point optical fiber core;
and
a first amplifier, coupled to the first anti-reflection device.

The present disclosure provides an optical fiber laser, comprising:
a first amplifier;
a first anti-reflection device, coupled to the first amplifier, further comprising:
   a first optical fiber, configured with a first fiber core; and
   a second optical fiber, configured with a second optical fiber core in a manner that the second optical fiber core is spliced to the first optical fiber core to form a spliced point f optical fiber core;
a first optical isolator, coupled to the first anti-reflection device; and
a seed laser, coupled to the first optical isolator.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a process for manufacturing an anti-reflection process according to the present disclosure.

FIG. 2 is a partial schematic view of a first fiber and a second optical fiber that are being spliced and a spliced point fiber core formed by the splice process.

FIG. 3 is a schematic diagram showing a fiber laser according to a first embodiment of the present disclosure.

FIG. 4 is a schematic diagram showing an optical fiber laser according to a second embodiment of the present disclosure.

FIG. 5 is a schematic diagram showing a fiber laser according to a third embodiment of the present disclosure.

FIG. 6 is a curve diagram illustrating results of a backward power monitoring based upon power setting.

FIG. 7 is a curve diagram illustrating results of a forward power monitoring based upon power setting.

FIG. 8 is a curve diagram illustrating the relationship between optical fiber diameter and the corresponding electric field distribution.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

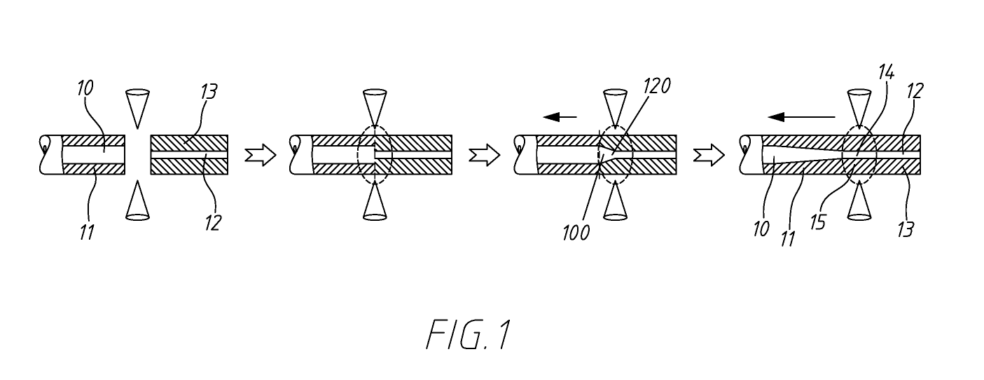

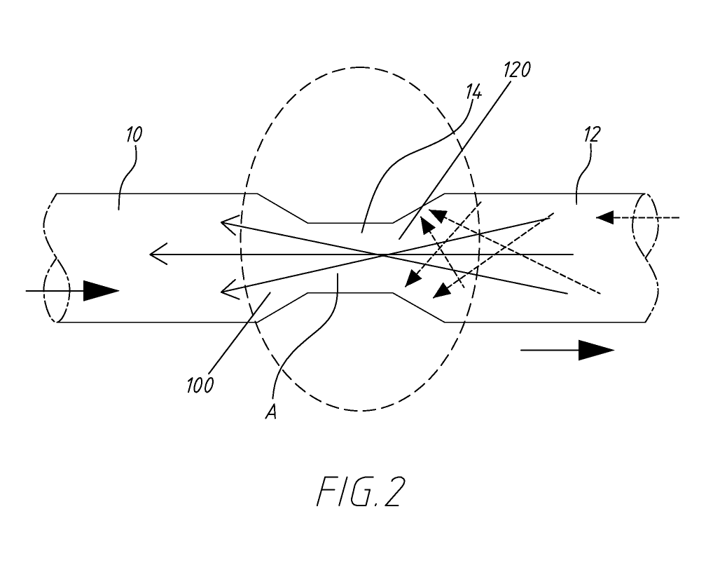

In an embodiment shown in FIG. 1 and FIG. 2, an anti-reflection device is disclosed, which comprises: a first optical fiber 10, a first optical fiber core 100, a second optical fiber 12 and a second optical fiber core 120, in which the first optical fiber 10 has a first cladding 11 disposed wrapping around the periphery thereof while allowing the first optical fiber core 100 to be received inside the first optical fiber 10; the second optical fiber 12 has a second cladding 13 disposed wrapping around the periphery thereof while allowing the second optical fiber core 120 to be received inside the second optical fiber 12.

Moreover, the first optical fiber core 100 is spliced to the second optical fiber core 120 to form a spliced point optical fiber core 14, and the spliced point optical fiber core 14 also has a third cladding 15 disposed wrapping around the periphery thereof. In addition, the two ends of the spliced point optical fiber core 14 are coupled respectively to one end of the first optical fiber 10 and one end of the second optical fiber 12.

As shown in FIG. 1, a method for manufacturing an anti-reflection device is disclosed, which comprises the step of: providing a fusion splicer to perform a parameter setup process upon at least one optical fiber so as to proceed with a splice process on the at least one optical fiber based on the result of the parameter setup process. Moreover, the at least one optical fiber can include the aforesaid first and second f optical fibers 10, 12, but is not limited thereby.

In addition, the parameters being set in the parameter setup process includes: a core size, a cladding size, a mode field diameter, a discharge cleaning time, a discharge cleaning current, a f optical fiber alignment distance, an optical fiber splicing distance, a pre-fusion time, a pre-fusion power, a splicer discharging time, a splicer discharging power, an optical fiber alignment pattern, a stretching time, a stretching speed, a stretching distance; and the fusion splicer is provided for setting parameters relating to the material, type and specification of the at least one optical fiber; and the splice process includes a fiber alignment operation, an end surface preheating operation, an optical fiber splicing operation and an optical fiber fusion stretching operation.

Operationally, one end of the first fiber is aligned and met to a corresponding end of the second optical fiber, whereas the aligning of the first optical fiber and the second optical fiber is performed in a mode selected from the group consisting of: a core aligning mode, a cladding aligning mode, a power alignment system (PAS) mode and an end view (EV) mode. Generally, a common optical fiber can be divided into two parts, one of which is referred as an inner core, while the other is referred as an outer cladding. Therefore, the aforesaid first core 100, second core 120 and spliced point fiber core 14 are inner cores, while the first cladding 11, the second cladding 13 and the third cladding 15 are the outer claddings.

In the aforesaid core aligning mode, the first optical fiber core 100 and the second fiber core 120 are aligned to each other; and in the aforesaid cladding aligning mode, the first cladding 11 and the second cladding 13 are aligned to each other. In addition, in the PAS mode, which is also referred as an image alignment mode. The two optical fibers are aligned to each other via the use of an optical image system. Moreover, in the EV mode, the corresponding ends of the two optical fibers that are to be aligned to each other are imaged respectively and used for aligning the two fibers.

After aligning, the corresponding ends of the two optical fibers 10, 12 are preheated to a melding state so as to fusion splicing the first optical fiber 10 to the second optical fiber 12, i.e. to fusion splicing the first optical fiber core 100 to the second fiber core 120 so as to form a spliced point optical fiber core 14.

Operationally, either the first optical fiber 10 or the second optical fiber 12 is defined to be stretched by a specified stretch distance, and thereby, the spliced point optical fiber core 14 is stretched. It is noted that the stretching can be performed in a manner selected from the group consisting of: only the first optical fiber 10 is being stretched, only the second f optical fiber 12 is being stretched, both the first and the second optical fibers 10, 12 are stretched simultaneously; and moreover, the stretching is being restricted by the following relationship: 10 μm<the specified stretch distance<2 mm.

In this embodiment, the first and the second fibers 10, 12 are formed respectively with a mode field diameter (D_{MFD}), whereas 4 μm<D_{MFD}<105 μm. Moreover, the first and the second optical fibers 10, 12 are formed respectively with a diameter (D_{CA}), and after stretching, the diameters of the first and the second optical fibers 10, 12 are transformed respectively into a stretched diameter (D_{SCA}), while D_{SCA}<D_{CA}; and the first and the second fiber cores 100, 120 are formed respectively with a core diameter (D_{CO}), and spliced point fiber core 14 is formed with a stretched diameter (D_{SCO}), while D_{CO}>D_{SCO}. In addition, the aforesaid D_{CO} and D_{CA} are defined by the following relationship: 4 μm<D_{CO}<105 μm; and 125 μm<D_{CA}<450 μm.

In this embodiment, the first fiber core 100 is featured by an initial laser power (Pₛᵢ), being the laser power inputted to the optical fibers at the splice point during the fusion splicing; the second optical fiber core 120 is featured by a reversed laser power (Pₛᵣ), being the reverse laser power inputted to the optical fibers at the splice point during the fusion splicing; and the spliced point fiber core 14 is featured by a laser damage threshold (P_{threshold}), identifying the laser damage threshold of the fibers at the splice point during the fusion splicing. Thereby, in a condition when Pₛᵣ>P_{threshold}, the fibers at the splice poi optical nt during the proceeding of the fusion splicing will be damaged, i.e. the spliced point optical fiber core 14 will be damaged.

In FIG. 2, a laser beam is travelling from the first optical fiber 10 toward the second optical fiber 12, while there is simultaneously a reflected laser beam travelling from the second optical fiber 12 toward the first fiber 10, so that heat will be accumulated at the area A. As soon as Pₛᵣ>P_{threshold}, the spliced point optical fiber core 14 will be damaged, and thus the travelling of the reflected laser beams will be blocked and stopped.

For proceeding the aforesaid fusion splicing, the type and brand of the fusion splicer are not limited. The following parameter settings used in the method for manufacturing an anti-reflection device are only for illustration, in which some are successful parameter settings and some are unsuccessful parameter setting, but there are not limited thereby and thus can be altered at will according to the type and size of the fibers used in the present disclosure.

In an embodiment, the parameters are set as following: the clamp spacing distance is set to be 250 mm; the arch bar are spaced from each other by 1 mm; a cleaning process is enabled every other 10 seconds; the diameter of fiber core is ranged between 4 μm and 20 μm, i.e. the diameters of the first and the second optical fibers 10, 12 are ranged respectively between 4 μm and 20 μm; the diameter of cladding is defined to be 125 μm, i.e. the diameters of the first and the second claddings 11, 13 are respectively 125 μm.

In addition, the following machining parameters are defined according a fusion splicer used in an embodiment of the present disclosure, which can be different when different fusion splicers are used. Thus, the following description is only for illustration and thus the parameters are not limited thereby.

In this embodiment, the mode field diameter (MFD) is ranged between 4 μm to 20 μm, or 4 μm to 105 μm; the cladding is orientated according to a XY axial orientation; the cleaning arc is defined to be 150 ms; the spacing is defined to be 10 μm; the overlap is 15 μm; the prefuse power is 20 bit; the prefuse time is 180 ms; the arc power is 20 bit; the arc time is 2000 ms; the stretching waiting time is 500 ms; the stretching speed is 100 bit; and the stretching time is 100 ms. Although the aforesaid parameters had been proven to be used successfully in the making of the anti-reflection device, but they are not limited thereby. The following are several examples, in which some of the aforesaid parameters are set differently, resulting failed anti-reflection device:
unsuccessful example 1: prefuse power is set to be ranged between 40 bit to 100 bit, while allowing the other parameters to remain unchanged.
unsuccessful example 2: prefuse time is set to be ranged between 250 ms to 700 ms, while allowing the other parameters to remain unchanged.
unsuccessful example 3: arc power is set to be ranged between 40 bit to 100 bit, while allowing the other parameters to remain unchanged.
unsuccessful example 4: arc time is set to be ranged between 2200 ms to 4600 ms, while allowing the other parameters to remain unchanged.
unsuccessful example 5: stretching waiting time is set to be ranged between 550 ms to 750 ms, while allowing the other parameters to remain unchanged.

The plural sets of parameters are given only for illustrating that in the making of the anti-reflection device, a good number of trial-and-error efforts had been made repetitively before a feasible set of parameter can be obtained, but it is not limited thereby.

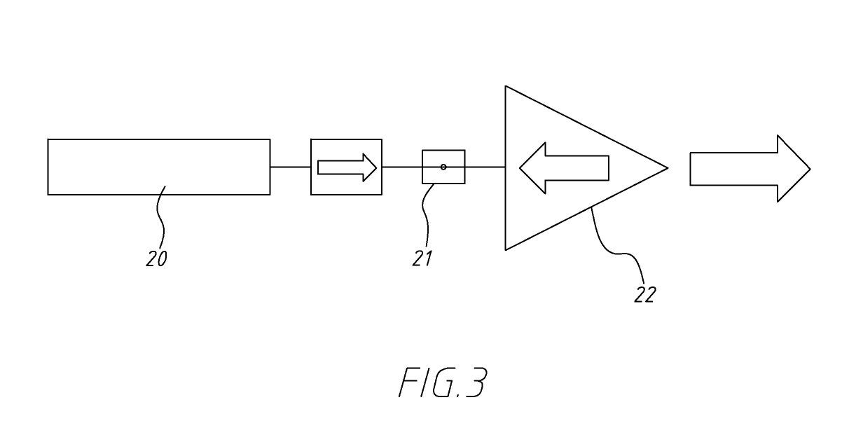

Please refer to FIG. 3, which is a schematic diagram showing an optical fiber laser according to a first embodiment of the present disclosure. In this first embodiment, a fiber laser is disclosed, which comprises: a seed laser 20, a first anti-reflection device 21 and a first amplifier 22. The seed laser 20 is coupled to the first anti-reflection device 21, whereas the first anti-reflection device is the one shown in FIG. 1 and FIG. 2, and thus will not be described further herein. In addition, the first anti-reflection device 21 is coupled to the first amplifier, and the first amplifier 22 in this embodiment is a master oscillator power amplifier (MOPA).

As shown in FIG. 3, operationally, the seed laser 20 emits a laser beam, which is being projected to be first anti-reflection device 21 and travelling passing through the same into the first amplifier 22 for enabling the power of the laser beam to be amplified.

After amplifying, the amplified laser beam may be reflected back to the first anti-reflection device 21 by way of: beam reflection, Rayleigh scattering, Stimulated Raman scattering, Stimulated Brillouin scattering, Fresnel reflection or reflection from a laser machining object.

When the amplified laser beam is reflected to the first anti-reflection device 21 and if the power of amplified laser beam is larger than a laser damage threshold (P_{threshold}), the spliced point optical fiber core will be damaged instantly and burn out, by that the amplified laser beam is prevented from being reflected back to the seed laser 20.

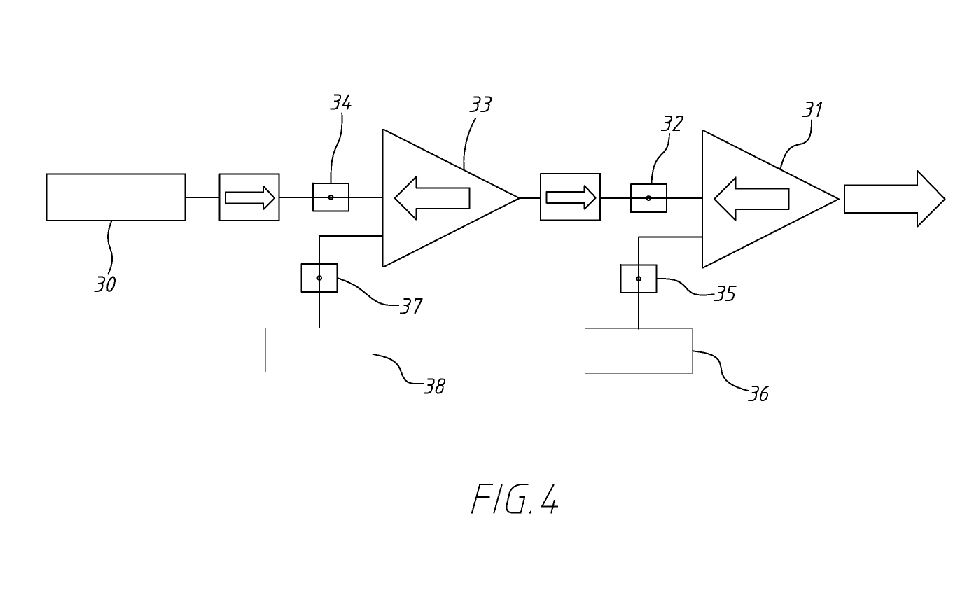

Please refer to FIG. 4, which is a schematic diagram showing an optical fiber laser according to a second embodiment of the present disclosure. In this second embodiment, an optical fiber laser is disclosed, which is an extension to the first embodiment, and comprises: a seed laser 30, a first amplifier 31, a first anti-reflection device 32, a second amplifier 33, a second anti-reflection device 34, a third anti-reflection device 35, a first pump laser 36, a fourth anti-reflection device 37 and a second pump laser 38.

The first amplifier 31 is coupled respectively to the first anti-reflection device 32 and the third anti-reflection device 35; the third anti-reflection device 35 is coupled to the first pump laser 36; the second amplifier 33 is coupled respectively to the second anti-reflection device 34 and the fourth anti-reflection device 37; and the fourth anti-reflection device 37 is coupled to the second pump laser 38.

Operationally, a main laser beam emitted from the seed laser 30 is projected to travel sequentially passing through the second anti-reflection device 34, the second amplifier 33, the first anti-reflection device 32 and the first amplifier 31 so as to generate an output laser beam, whereas the first pump laser 36 and the second pump laser 38 are enabled to respectively emit an auxiliary laser beam to be used for enhancing the power of the main laser beam emitted from the seed laser 30. Moreover, the powers of the main laser beam and the two auxiliary laser beams are enhanced by the amplification of the first amplifier 31 or the second amplifiers 33.

Similarly, when the output laser beam, the main laser beam and the auxiliary laser beam are reflected in any way referred in the above description, the first, second, third and fourth anti-reflection devices 32, 34, 35, 37 will be burned out for protecting the seed laser 30, the first pump laser 36, the second pump laser 38, or the second amplifier 33. Thereby, the seed laser 30, the first pump laser 36, the second pump laser 38, or the second amplifier 33 can be prevented from being damaged by the reflected laser beams.

In addition, the third anti-reflection device 35 is disposed at a position between the first pump laser 36 and the first amplifier 31, while the fourth anti-reflection device 37 is disposed at a position between the second amplifier 33 and the second pump laser 38, by that both the first and the second amplifiers 31, 33 can be prevented from being damaged by laser beam emitted from the pump lasers 36, 38. That is, when the instant power of the laser beam is larger than the defined thresholds of the corresponding amplifiers 31, 33, the anti-reflection devices 35, 37 will be burned out instantly for protecting the amplifiers 31, 33. It is noted that the first, the second, the third and the fourth anti-reflection devices 32, 34, 35, 37 are the same as the one shown in FIG. 1 and FIG. 2, and thus will not be described further herein.

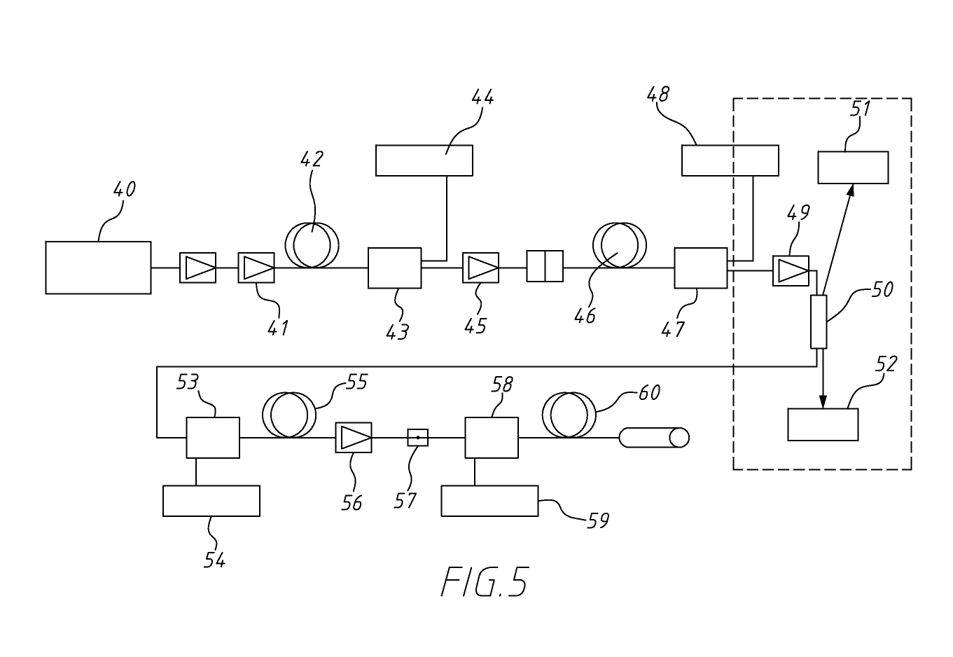

Please refer to FIG. 5, which is a schematic diagram showing a fiber laser according to a third embodiment of the present disclosure. In this third embodiment, a fiber laser is disclosed, which comprises: a seed laser 40, a fourth optical isolator 41, a fourth optical fiber 42, a fourth amplifier 43, a fourth pump laser 44, a third optical isolator 45, a third optical fiber 46, a third amplifier 47, a third pump laser 48, a second optical isolator 49, a fiber coupler 50, a backward monitor 51, a forward monitor 52, a second amplifier 53, a second pump laser 54, a second optical fiber 55, a first optical isolator 56, a first anti-reflection device 57, a first amplifier 58, a first pump laser 59 and a first optical fiber 60.

The seed laser 40 is coupled to the fourth optical isolator 41; the fourth optical isolator 41 is coupled to the first optical fiber 42, whereas there can be at least one such fourth optical isolator 41. Moreover, the fourth optical fiber 42 is coupled to the fourth amplifier 43; the fourth amplifier 43 is coupled respectively to the fourth pump laser 44 and the third optical isolator 45; the third optical isolator 45 is coupled to the third optical fiber 46; the third optical fiber 46 is coupled to the third amplifier 47; the third amplifier 47 is coupled respectively to the second optical isolator 49 and the third pump laser 48; the second optical isolator 49 is coupled to the optical fiber coupler 501; the optical fiber coupler 50 is coupled respectively to the backward monitor 51, the forward monitor and the second amplifier 53; the second amplifier 53 is coupled respectively to the second optical fiber 55 and the second pump laser 54; the first optical isolator 56 is coupled respectively to the second optical fiber 55 and the first anti-reflection device 58; and the first amplifier 58 is coupled respectively to the first pump laser 59 and the first optical fiber 60.

Similar to the fiber laser described in the second embodiment, there are anti-reflection devices being disposed positions between the fourth pump laser 44 and the fourth amplifier 43, and/or between the third pump laser 48 and the third amplifier 47, and/or between the second pump laser 54 and the second amplifier 53, and/or between the first pump laser 59 and the first amplifier 58.

Operationally, a main laser beam is emitted from the seed laser 40 whereas the first pump laser 44, the second pump laser 48, the third pump laser 54 and the fourth pump laser 59 are enabled to emit respectively an auxiliary laser beam, and similarly, the power of the main laser beam as well as the auxiliary laser beams are enhanced by the fourth amplifier 43, the third amplifier 47, the second amplifier 53 and the first amplifier 58 is sequence, and thereby, an output laser beam is generated.

When the output laser beam is reflected in any way referred in the above description, the first anti-reflection devices 57 will be burned out for protecting the seed laser 40, the fiber coupler 50, the first, second, third and fourth optical isolators 56, 49, 45, 41, and/or the first, second, third and fourth amplifiers 58, 53, 47, 43, and/or each and every other components disposed between the seed laser 50 and the first optical fiber 60. That is, for any position between an amplifier and an pump laser, there must be at least one anti-reflection device being disposed thereat, and thereby, when the instant power of the laser beam from the pump laser is larger than the defined thresholds of the corresponding amplifier, or the reflected laser beam is reflected back to the pump laser, the anti-reflection devices will be burned out instantly for protecting the corresponding amplifiers and/or pump lasers.

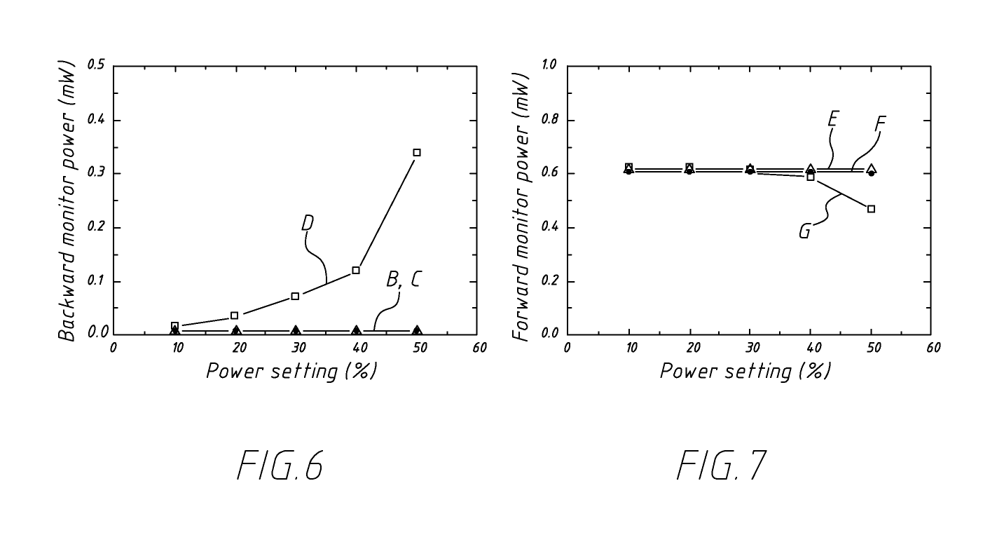

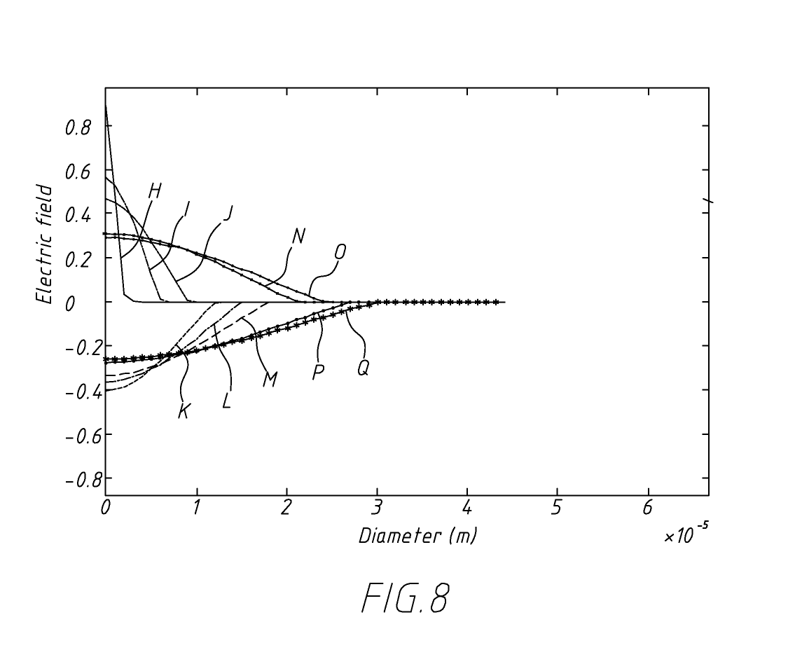

Please refer to FIG. 6 and FIG. 7, which are respectively a curve diagram illustrating results of a backward power monitoring based upon power setting, and a curve diagram illustrating results of a forward power monitoring based upon power setting.

In FIG. 6, the curves B and C are results of backward monitoring obtained when the laser beam is not reflected, and thus backward monitor powers of the curves B and C remain unchanged with different power settings. On the other hand, the curve D is obtained when the laser beam is reflected and thereby the power of the laser beam is enhanced.

In FIG. 7, the curves E and F are results of forward monitoring obtained when the laser beam is not reflected, that are corresponding respectively to the curves B and C of FIG. 6, and thus, similarly the backward monitor powers of the curves E and F remain unchanged with different power settings. On the other hand, the curve G, which is corresponding to the curve D of FIG. 6, is obtained when the laser beam is reflected and thereby the power of the laser beam is enhanced, but since the anti-reflection device can not sustain the enhanced reflected laser beam and thus is being burned out instantly.

Please refer to FIG. 8, which is a curve diagram illustrating the relationship between fiber diameter and the corresponding electric field distribution. The electric field in an optical fiber can be described by the following formula:

E(r,φ,z)=E₀(r)e^{i(ωt-β}^{₀}^{z)}e^{ivκ}

wherein, E represents an electric field; φ represents an orientation angle relating to a specific point in an optical fiber; r represents the radius of the optical fiber; z represents a position of the electric field on a Z axis in the optical fiber; v represent a speed of the electric field.

The distribution of electric field for cores of different sizes can be obtained by the derivation using Maxwell equation in cylindrical coordinate, as following:

$$\frac{{\partial }^{2} E}{\partial {r}^{2}} + \frac{1}{r} \frac{\partial E}{\partial r} - \frac{{v}^{2}}{{r}^{2}} E + ( {β}^{2} - {β}_{0}^{2} ) E = 0$$

wherein, β represents a propagation constant in a specific medium; β₀ represents the propagation constant in vacuum.

In FIG. 8. the curves H to Q represents the electric field variations for cores of different diameters. The core diameter for curve H is 2 μm; the core diameter for curve I is 5.1111 μm; the core diameter for curve J is 8.222 μm; the core diameter for curve K is 11.333 μm; the core diameter for curve L is 14.444 μm; the core diameter for curve M is 17.5556 μm; the core diameter for curve N is 20.337 μm; the core diameter for curve O is 23.778 μm; the core diameter for curve p is 26.889 μm; and the core diameter for curve q is 30 μm. As shown in FIG. 8, cores of different diameters are featured by their respective threshold electric fields, and consequently a core will be burned out if its threshold electric field is exceeded for causing a heat accumulation area to be generated. By the aforesaid characteristic, the optical fiber core will be burned out instantly when the power of laser beam is larger than the threshold of the fiber core, and thereby, the seed laser, the amplifiers, the pump lasers, the optical fiber coupler, the optical isolators and/or the drop multiplexer are protected. In addition, the shortcomings including: the output power of an optical fiber laser system being degraded, the laser output end being damaged, the optical components in the laser amplifiers being damaged; and the seed laser being damaged, can be prevented.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A method for manufacturing an anti-reflection device, comprising the step of:
performing a parameteric setup process in light of at least an optical fiber by use of a fusion splicer so as to proceed with a splice process on the at least one optical fiber based on the result of the parameter setup process, while enabling an optical fiber alignment operation, an end surface preheating operation, an optical fiber splicing operation and an optical fiber fusion stretching operation during the proceeding of the splice process.

2. The method of claim 1, wherein parameters being set in the parameter setup process includes: a core size, a cladding size, a mode field diameter, a discharge cleaning time, a discharge cleaning current, an optical fiber alignment distance, a fiber splicing distance, a pre-fusion time, a pre-fusion power, a splicer discharging time, a splicer discharging power, an optical fiber alignment pattern, a stretching time, a stretching speed, a stretching distance; and the fusion splicer is provided for setting parameters relating to the material, type and specification of the at least one optical fiber.

3. The method of claim 1, wherein the at least one optical fiber includes: a first optical fiber having a first fiber core, and a second fiber having a second optical fiber core; and the first optical fiber core is spliced to the second optical fiber core to form a spliced point optical fiber core, while allowing either the first optical fiber or the second optical fiber to be stretched for enabling the spliced point optical fiber core to be stretched consequently.

4. The method of claim 3, wherein the first optical fiber core is featured by an initial laser power (Pₛᵢ), the second optical fiber core is featured by a reversed laser power (Pₛᵣ), and the spliced point fiber core is featured by a laser damage threshold (P_{threshold}), and the laser damage threshold (P_{threshold}) is defined by the following relationship:
Pₛᵣ>P_{threshold}>Pₛᵢ.

5. The method of claim 3, wherein one end of the first optical fiber is aligned and met to a corresponding end of the second optical fiber, while allowing the two corresponding ends of the first and the second optical fibers to be preheated to a melting state so as to fusion splicing the first optical fiber to the second optical fiber.

6. The method of claim 3, wherein the first optical fiber has a first cladding disposed wrapping around the periphery thereof; the second fiber has a second cladding disposed wrapping around the periphery thereof; the spliced point optical fiber core has a third cladding disposed wrapping around the periphery thereof; the first and the second optical fibers are formed respectively with a diameter (D_{CA}), and after stretching, the diameters of the first and the second optical fibers are transformed respectively into a stretched diameter (D_{SCA}), while D_{SCA}<D_{CA}; and the first and the second optical fiber cores are formed respectively with a core diameter (D_{CO}), and spliced point fiber core is formed with a stretched diameter (D_{SCO}), while D_{CO}>D_{SCO}.

7. The method of claim 6, wherein 4 μm<D_{CO}<105 μm; and 125 μm<D_{CA}<450 μm.

8. The method of claim 3, wherein the first and the second optical fibers are formed respectively with a mode field diameter (D_{MFD}).

9. The method of claim 8, wherein 4 μm<D_{MFD}<105 μm.

10. The method of claim 3, wherein either the first fiber or the second optical fiber is defined to be stretched by a specified stretch distance.

11. The method of claim 10, wherein 10 μm<the specified stretch distance<2 mm.

12. The method of claim 5, wherein the aligning of the first optical fiber and the second optical fiber is performed in a mode selected from the group consisting of: a core aligning mode, a cladding aligning mode, a power alignment system (PAS) mode and an end view (EV) mode.

13. An anti-reflection device, comprising:
a first optical fiber, having a first optical fiber core; and
a second optical fiber, having a second optical fiber core which is fusion spliced to the first fiber core to form a spliced point optical fiber core.

14. The anti-reflection device of claim 13, wherein the first optical fiber core is featured by an initial laser power (Pₛᵢ), the second optical fiber core is featured by a reversed laser power (Pₛᵣ), and the spliced point optical fiber core is featured by a laser damage threshold (P_{threshold}), and the laser damage threshold (P_{threshold}) is defined by the following relationship:
Pₛᵣ>P_{threshold}>Pₛᵢ.

15. The anti-reflection device of claim 13, wherein the first optical fiber has a first cladding disposed wrapping around the periphery thereof; the second optical fiber has a second cladding disposed wrapping around the periphery thereof; the spliced point optical fiber core has a third cladding disposed wrapping around the periphery thereof; the first and the second optical fibers are formed respectively with a diameter (D_{CA}), and after stretching, the diameters of the first and the second optical fibers are transformed respectively into a stretched diameter (D_{SCA}), while D_{SCA}<D_{CA}; and the first and the second optical fiber cores are formed respectively with a core diameter (D_{CO}), and spliced point optical fiber core is formed with a stretched diameter (D_{SCO}), while D_{CO}>D_{SCO}.

16. The anti-reflection device of claim 15, wherein 4 μm<D_{CO}<105 μm; and 125 μm<D_{CA}<450 μm.

17. The anti-reflection device of claim 13, wherein the first and the second optical fibers are formed respectively with a mode field diameter (D_{MFD}).

18. The anti-reflection device of claim 17, wherein 4 μm<D_{MFD}<105 μm.

19. An optical fiber laser, comprising:
a seed laser;
a first anti-reflection device, coupled to the seed laser, further comprising:
a first optical fiber, having a first optical fiber core; and
a second optical fiber, having a second optical fiber core which is fusion spliced to the first fiber core to form a spliced point optical fiber core;
and
a first amplifier, coupled to the first anti-reflection device.

20. The optical fiber laser of claim 19, wherein the first optical fiber core is featured by an initial laser power (Pₛᵢ), the second optical fiber core is featured by a reversed laser power (Pₛᵣ), and the spliced point optical fiber core is featured by a laser damage threshold (P_{threshold}), and the laser damage threshold (P_{threshold}) is defined by the following relationship:
Pₛᵣ>P_{threshold}>Pₛᵢ.

21. The optical fiber laser of claim 19, wherein the first optical fiber has a first cladding disposed wrapping around the periphery thereof; the second optical fiber has a second cladding disposed wrapping around the periphery thereof; the spliced point fiber core has a third cladding disposed wrapping around the periphery thereof; the first and the second optical fibers are formed respectively with a diameter (D_{CA}), and after stretching, the diameters of the first and the second optical fibers are transformed respectively into a stretched diameter (D_{SCA}), while D_{SCA}<D_{CA}; and the first and the second fiber cores are formed respectively with a core diameter (D_{CO}), and spliced point optical fiber core is formed with a stretched diameter (D_{SCO}), while D_{CO}>D_{SCO}.

22. The optical fiber laser of claim 21, wherein 4 μm<D_{CO}<105 μm; and 125 μm<D_{CA}<450 μm.

23. The optical fiber laser of claim 19, wherein the first and the second optical fibers are formed respectively with a mode field diameter (D_{MFD}).

24. The optical fiber laser of claim 23, wherein 4 μm<D_{MFD}<105 μm.

25. The optical fiber laser of claim 19, further comprising:
a first pump laser; and
a third anti-reflection device, coupled to the first pump laser.

26. The optical fiber laser of claim 25, further comprising:
a second pump laser;
a second anti-reflection device, coupled to the seed laser;
a fourth anti-reflection device, coupled to the second pump laser; and
a second amplifier, coupled respectively to the first anti-reflection device, the second anti-reflection device and the fourth anti-reflection device.

27. An optical fiber laser, comprising:
a first amplifier;
a first anti-reflection device, coupled to the first amplifier, further comprising:
a first optical fiber, having a first optical fiber core; and
a second optical fiber, having a second optical fiber core which is fusion spliced to the first fiber core to form a spliced point optical fiber core;
a first optical isolator, coupled to the first anti-reflection device; and
a seed laser, coupled to the first optical isolator.

28. The optical fiber laser of claim 27, wherein the first optical fiber core is featured by an initial laser power (Pₛᵢ), the second optical fiber core is featured by a reversed laser power (Pₛᵣ), and the spliced point fiber core is featured by a laser damage threshold (P_{threshold}), and the laser damage threshold (P_{threshold}) is defined by the following relationship:
Pₛᵣ>P_{threshold}>Pₛᵢ.

29. The optical fiber laser of claim 27, wherein the first optical fiber has a first cladding disposed wrapping around the periphery thereof; the second optical fiber has a second cladding disposed wrapping around the periphery thereof; the spliced point optical fiber core has a third cladding disposed wrapping around the periphery thereof; the first and the second optical fibers are formed respectively with a diameter (D_{CA}), and after stretching, the diameters of the first and the second optical fibers are transformed respectively into a stretched diameter (D_{SCA}), while D_{SCA}<D_{CA}; and the first and the second optical fiber cores are formed respectively with a core diameter (D_{CO}), and spliced point fiber core is formed with a stretched diameter (D_{SCO}), while D_{CO}>D_{SCO}.

30. The optical fiber laser of claim 29, wherein 4 μm<D_{CO}<105 μm; and 125 μm<D_{CA}<450 μm.

31. The optical fiber laser of claim 27, wherein the first and the second optical fibers are formed respectively with a mode field diameter (D_{MFD}).

32. The fiber laser of claim 31, wherein 4 μm<D_{MFD}<105 μm.

33. The fiber laser of claim 27, further comprising: a first laser fiber, a first pump laser, a second laser optical fiber, a second pump laser, a second amplifier, an optical fiber coupler, a forward monitor, a backward monitor, a second optical isolator, a third amplifier, a third pump laser, a third laser optical fiber, a third optical isolator, a fourth pump laser, a fourth amplifier, and a fourth optical isolator; wherein, the first laser optical fiber is coupled to the first amplifier; the first pump laser is coupled to the second amplifier; the optical fiber coupler is coupled to the second amplifier; the forward monitor is coupled to the optical fiber coupler; the backward monitor is coupled to the fiber coupler; the second optical isolator is coupled to the optical fiber coupler; the third amplifier is coupled to the second optical isolator; the third pump laser is coupled to the third amplifier; the third laser optical fiber is coupled to the third amplifier; the third optical isolator is coupled to the third laser optical fiber; the fourth amplifier is coupled to the third laser optical fiber; the fourth pump laser is coupled to the fourth amplifier; the fourth laser optical fiber is coupled to the fourth amplifier; the fourth optical isolator is coupled to the fourth laser optical fiber; and the fourth optical isolator is coupled to the seed laser.

34. The optical fiber laser of claim 33, further comprising:
an additional anti-reflection device, disposed at a position selected from the group consisting of: a position between the fourth laser pump and the fourth amplifier, a position between the third laser pump and the third amplifier, a position between the second laser pump and the second amplifier, and a position between the first laser pump and the first amplifier.
